(19) United States
(12) Patent Application Publication
(10) Pub. No.: US 2015/0228948 A1
(43) Pub. Date: Aug. 13, 2015

(54) MICROPOROUS MEMBER, METHOD FOR PRODUCING SAME, BATTERY SEPARATOR, AND RESIN COMPOSITION FOR NONAQUEOUS ELECTROLYTE SECONDARY BATTERY SEPARATOR

(71) Applicant: DIC Corporation, Tokyo (JP)

(72) Inventors: Yutaka Maruyama, Ichihara-shi (JP); Akira Kawamura, Ichihara-shi (JP)

(21) Appl. No.: 14/424,202

(22) PCT Filed: Aug. 29, 2013
(86) PCT No.: PCT/JP2013/073125

§ 371 Date: Feb. 26, 2015

(30) Foreign Application Priority Data
Aug. 30, 2012 (JP) 2012-189945

(51) Int. Cl. H01M 2/16; H01M 2/14; C08J 9/00

(52) U.S. Cl. CPC H01M 2/162; C08J 9/0061; H01M 2/1653; H01M 2/145; C08J 2323/02; C08J 2333/14; C08J 2351/00; C08J 2381/04

(57) ABSTRACT

Provided are a microporous membrane including a thermoplastic resin having a melting point of 220° C. or more and a polyolefin, the thermoplastic resin (a) having an acicular structure, and a method for producing the microporous membrane. The microporous membrane has high resistance to thermal shrinkage since it includes a polyolefin and a high-melting-point thermoplastic resin having an acicular structure. Thus, a battery separator for nonaqueous electrolyte secondary batteries and, in particular, a single-layer battery separator for nonaqueous electrolyte secondary batteries which have a good shut-down function and high resistance to thermal shrinkage may be produced.

### TECHNICAL FIELD

The present invention relates to a microporous membrane, in particular, a microporous membrane used as a battery separator for nonaqueous electrolyte secondary batteries, a method for producing such a membrane, and a resin composition used for producing the battery separator for nonaqueous electrolyte secondary batteries.

### BACKGROUND ART

With the widespread use of cordless and portable electronic equipment, attention has been directed toward use of nonaqueous electrolyte secondary batteries such as lithium-ion secondary batteries, which have a high electromotive force and a low self-discharge rate, as power sources for operating such electronic equipment. In particular, as the energy densities of the nonaqueous electrolyte secondary batteries have increased, the nonaqueous electrolyte secondary batteries have been increasingly used in mobile applications as well as existing electronic-equipment applications. Thus, further enhancement of the safety of the nonaqueous electrolyte secondary batteries has been anticipated.

A nonaqueous electrolyte secondary battery includes a separator interposed between positive and negative electrodes in order to prevent short-circuiting of the electrodes. As a separator, for example, a membrane having a number of micropores formed therein (hereinafter, referred to as “microporous membrane”) is used in order to allow ions to pass through the separator between the electrodes. Currently, polyolefin microporous membranes are used as such a microporous membrane because they have good mechanical properties and a function of interrupting a current by closing the pores of the microporous membrane when the battery temperature is increased, that is, a “shut-down function”. However, when the temperature of a nonaqueous electrolyte secondary battery continues to increase due to thermal runaway, a separator including the polyolefin microporous membrane may break due to thermal shrinkage, which causes short-circuiting of the electrodes, that is, “meltdown”, to occur.

Therefore, the microporous membrane requires the shut-down function and “resistance to thermal shrinkage” in order to prevent meltdown from occurring. However, the shut-down function and resistance to thermal shrinkage are mutually incompatible properties because the working principle of the shut-down function uses blockage of the pores which is achieved by melting polyolefin.

In order to enhance the resistance to thermal shrinkage and to achieve the shut-down function, a microporous membrane produced by dispersing spherical microparticles of polybutylene terephthalate (PBT) having a high melting point, the microparticles having a diameter of 1 to 10 μm, in a phase including a polyolefin matrix has been proposed (see PTL 1). However, the above-described microporous membrane did not have sufficient resistance to thermal shrinkage and required further improvement.

### CITATION LIST

### Patent Literature

[PTL 1] Japanese Unexamined Patent Application Publication No. 2004-149637

### SUMMARY OF INVENTION

### Technical Problem

Accordingly, an object of the present invention is to provide a microporous membrane and, in particular, a microporous membrane used as a battery separator for nonaqueous electrolyte secondary batteries which have high resistance to thermal shrinkage, the microporous membrane including a polyolefin and a high-melting-point thermoplastic resin, and to provide a method for producing the microporous membrane and a resin composition used for producing a battery separator for nonaqueous electrolyte secondary batteries.

### Solution to Problem

In order to address the above-described problems, the inventors of the present invention have conducted extensive studies and, as a result, found that a microporous membrane including a high-melting-point thermoplastic resin having an acicular structure has high resistance to thermal shrinkage. Thus, the present invention was made.

Specifically, the present invention relates to a microporous membrane including a thermoplastic resin (a) having a melting point of 220° C. or more and a polyolefin, the thermoplastic resin (a) having an acicular structure.

The present invention also relates to a battery separator including the above-described microporous membrane.

The present invention further relates to a method for producing a microporous membrane, the method including the steps of (1) melt-kneading a thermoplastic resin (a) having a melting point of 220° C. or more with a polyolefin (b) at a temperature equal to or higher than the melting point of the thermoplastic resin (a) to prepare a resin composition (α); (2) melt-kneading the resin composition (α) with a pore-forming agent (d1) or with a β-phase-nucleating agent (d2) at a temperature higher than the melting point of the thermoplastic resin (a) by 10° C. or more to prepare a melt-kneaded mixture (β); (3) forming the melt-kneaded mixture (β) into a sheet to prepare a sheet (γ) including the thermoplastic resin (a) having an acicular structure, the melt-kneaded mixture (β) being heated to the temperature higher than the melting point of the thermoplastic resin (a) by 10° C. or more; and (4) forming pores in the sheet (γ).

The present invention also relates to a method for producing a microporous membrane, the method including the steps of (1′) melt-kneading a thermoplastic resin (a) having a melting point of 220° C. or more with a polyolefin (b) in an extruder at a temperature higher than the melting point of the thermoplastic resin (a) by 10° C. or more, the extruder including a die attached to a side thereof, drawing the resulting melt-kneaded mixture to form a strand in such a manner that the ratio of the diameter of a die hole to the diameter of the strand is 1.1 or more, and subsequently cutting the strand to prepare a resin composition (α′) including the thermoplastic resin (a) having an acicular structure; (2′) kneading the resin composition (α′) with a pore-forming agent (d1) or with a β-phase-nucleating agent (d2) at a temperature equal to or higher than the melting point of the polyolefin (b) and equal to or lower than the melting point of the thermoplastic resin (a) to prepare a kneaded mixture (β′); (3′) forming the kneaded mixture (β′) into a sheet to prepare a sheet (γ) including the thermoplastic resin (a) having an acicular structure, the kneaded mixture (β′) being heated to the temperature equal to or higher than the melting point of the polyolefin (b) and equal to or lower than the melting point of the thermoplastic resin (a); and (4) forming pores in the sheet (γ).

The present invention further relates to a resin composition (α′) used for producing a battery separator for nonaqueous electrolyte secondary batteries, the resin composition (α′) being produced by melt-kneading a thermoplastic resin (a) having a melting point of 220° C. or more with a polyolefin (b) in an extruder at a temperature higher than the melting point of the thermoplastic resin (a) by 10° C. or more, the extruder including a die attached to a side thereof, drawing the resulting melt-kneaded mixture to form a strand in such a manner that the ratio of the diameter of a die hole to the diameter of the strand is 1.1 or more, and subsequently cutting the strand. The amount of the thermoplastic resin (a) is 1% to 73% by mass and the amount of the polyolefin (b) is 99% to 27% by mass of the total mass (a+b) of the thermoplastic resin (a) and the polyolefin (b). The thermoplastic resin (a) has an acicular structure.

### Advantageous Effects of Invention

According to the present invention, a microporous membrane and, in particular, a microporous membrane used as a battery separator for nonaqueous electrolyte secondary batteries which have high resistance to thermal shrinkage, the microporous membrane including a polyolefin and a high-melting-point thermoplastic resin having an acicular structure, a method for producing such a microporous membrane, and a resin composition used for producing a battery separator for nonaqueous electrolyte secondary batteries may be produced.

### BRIEF DESCRIPTION OF DRAWINGS

FIG. 1 is a micrograph of a sheet test piece prepared in Example 4, illustrating a structure in which a polyphenylene sulfide resin having an acicular structure is dispersed in a polyolefin matrix. The white network structure is a polyolefin formed when the test piece was cut for producing SEM images.

FIG. 2 is a micrograph of a sheet test piece prepared in Comparative Example 1, illustrating a structure in which a polyphenylene sulfide resin having a spherical structure is dispersed in a polyolefin matrix. The white network structure is a polyolefin formed when the test piece was cut for producing SEM images.

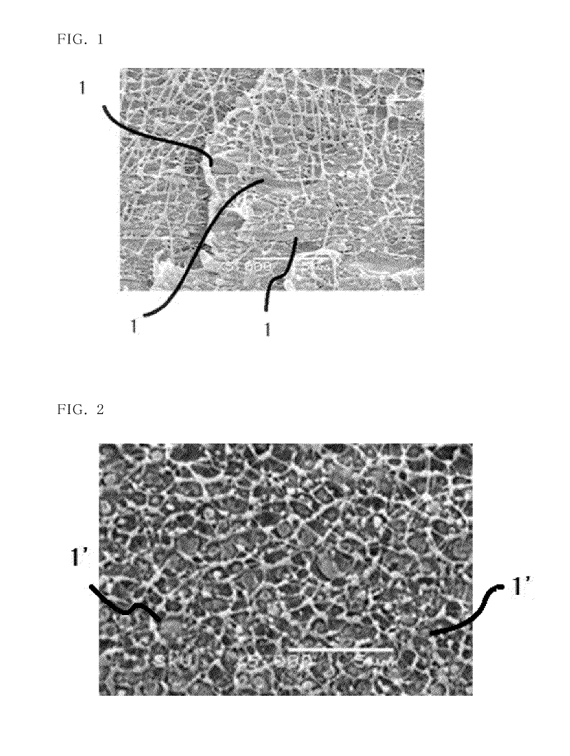

### DESCRIPTION OF EMBODIMENTS

The microporous membrane according to the present invention includes a thermoplastic resin having a melting point of 220° C. or more and a polyolefin. The thermoplastic resin has an acicular structure.

Thermoplastic Resin Having Melting Point of 220° C. or More

Examples of the thermoplastic resin used in the present invention include thermoplastic resins having a melting point of 220° C. or more and preferably having a melting point of 220° C. to 390° C., that is, for example, “commodity engineering plastics” and “super engineering plastics”. Specific examples of such thermoplastic resins include the following thermoplastic resins having a melting point of 220° C. to 390° C.: polyamides having a melting point of 220° C. or more and preferably having a melting point of 220° C. to 310° C., such as polyamides having an aliphatic backbone, such as polyamide 6 (nylon 6), polyamide 66 (nylon 6,6), and polyamide 12 (nylon 12), and polyamides having an aromatic backbone, such as polyamide 6T (nylon 6T) and polyamide 9T (nylon 9T); polyester resins having a melting point of 220° C. or more and preferably having a melting point of 220° C. to 280° C., such as polybutylene terephthalate, polyisobutylene terephthalate, polyethylene terephthalate, and polycyclohexene terephthalate; polyarylene sulfides having a melting point of 265° C. or more, preferably having a melting point of 265° C. to 350° C., and further preferably having a melting point of 280° C. to 300° C., such as polyphenylene sulfide; polyether ether ketone having a melting point of 300° C. to 390° C.; liquid crystal polymers whose backbones include para-hydroxybenzoic acid, the liquid crystal polymers having a melting point of 300° C. or more and preferably having a melting point equal to or higher than 300° C. and lower than the pyrolysis temperature (380° C.); and syndiotactic polystyrene having a melting point of 220 or more and preferably having a melting point of 220° C. to 280° C. Among the above-described thermoplastic resins, polyarylene sulfides are preferably used because they have good flame retardancy and good dimensional stability.

In the present invention, the molecular weight of the thermoplastic resin is not particularly limited as long as the advantageous effect of the present invention is not impaired. However, in order to reduce gasification and bleedout of the resin component which may occur during melt-kneading, the molecular weight of the thermoplastic resin is preferably 5 [Pa·s] or more in terms of the melt viscosity of the resin. The upper limit of the melt viscosity of the thermoplastic resin is not particularly limited. However, from the viewpoints of flowability and formability, the melt viscosity of the thermoplastic resin is preferably 3000 [Pa·s] or less and is most preferably 20 to 1000 [Pa·s]. The term “melt viscosity” used herein refers to melt viscosity of the thermoplastic resin which is measured at the temperature higher than the melting point of the thermoplastic resin by 20° C. using Flow Tester (Koka Flow Tester “Model: CFT-500D” produced by Shimadzu Corporation) with an orifice in which the ratio of the length thereof to the diameter thereof, that is, orifice length/orifice diameter, is 10/1 at a load of 1.96 MPa after holding 6 minutes. The term “melting point” used herein refers to a melting peak temperature measured by differential scanning calorimetry (DSC) in accordance with the method described in 9.1(1), JIS 7121 (1999).

The polyarylene sulfide resin, which is described above as a preferred example of the thermoplastic resin, is described below in detail.

The polyarylene sulfide resin that can be used in the present invention is a resin having a repeating unit that is a structure in which a sulfur atom is bonded to an aromatic ring, that is, specifically, a resin having a repeating unit that is the structural site represented by the Formula (1) below.

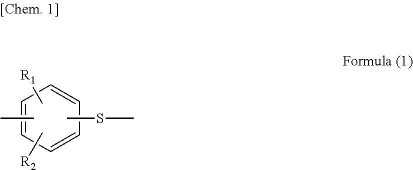

(In Formula (1), R¹ and R² each independently represent a hydrogen atom, an alkyl group having 1 to 4 carbon atoms, a nitro group, an amino group, a phenyl group, a methoxy group, and an ethoxy group)

In the structural site represented by Formula (1) above, in particular, R¹ and R² of the Formula (1) are preferably hydrogen atoms from the viewpoint of the mechanical strength of the polyarylene sulfide resin. In such a case, the sulfur atom is preferably bonded to the aromatic ring at the para position as illustrated in Formula (2) below.

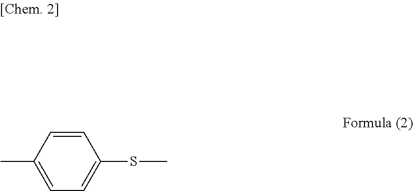

Among these, in particular, in the repeating unit, the sulfur atom is preferably bonded to the aromatic ring at the para position as illustrated in Structural Formula (2) above from the viewpoints of the heat resistance and crystallinity of the polyarylene sulfide resin.

The polyarylene sulfide resin may further include, in addition to the structural site represented by Formula (1) above, the structural sites represented by Structural Formulae (3) to (6) below in such a manner that the amount of the structural sites represented by Structural Formulae (3) to (6) is 30 mol % or less of the total amount of the structural site represented by Formula (1) above and the structural sites represented by Structural Formulae (3) to (6).

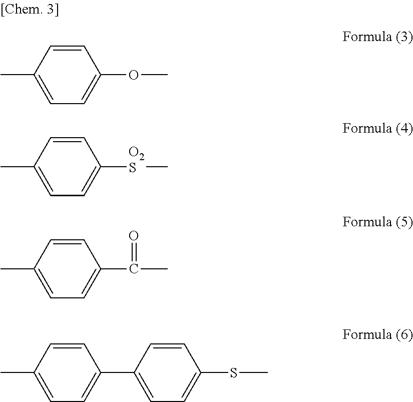

In the present invention, in particular, the proportion of the structural sites represented by Formulae (3) to (6) above is preferably 10 mol % or less from the viewpoints of the heat resistance and mechanical strength of the polyarylene sulfide resin. In the case where the polyarylene sulfide resin includes the structural sites represented by Formulae (3) to (6) above, bonding of the structural sites may be performed in the form of a random copolymer or a blocked copolymer.

The polyarylene sulfide resin may include a trifunctional structural site represented by Formula (7) below, a naphthyl-sulfide linkage, or the like in the molecular structure.

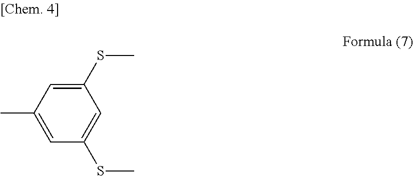

The amount of the trifunctional structural site, the naphthyl-sulfide linkage, or the like is preferably 3 mol % or less and is particularly preferably 1 mol % or less of the total number of moles of the trifunctional structural site, the naphthyl-sulfide linkage, or the like and the other structural sites included in the polyarylene sulfide resin.

The melt viscosity (V6) of the polyarylene sulfide resin is not particularly limited as long as the advantageous effect of the present invention is not impaired, but is preferably 5 to 3000 [Pa·s] and, in order to enhance flowability and to increase mechanical strength in a balanced manner, 20 to 1000 [Pa·s] when measured at 300° C. The non-Newtonian index of the polyarylene sulfide resin is not particularly limited as long as the advantageous effect of the present invention is not impaired, but is preferably 0.90 to 2.00. In the case where a linear polyarylene sulfide resin is used, the non-Newtonian index of the linear polyarylene sulfide resin is preferably 0.90 to 1.20, is more preferably 0.95 to 1.15, and is particularly preferably 0.95 to 1.10. The above-described polyarylene sulfide resin has good mechanical properties, good flowability, and high abrasion resistance. Note that the non-Newtonian index (N-value) is calculated using the following expression from shear rate and shear stress measured using Capilograph at 300° C. with an orifice in which the ratio of the orifice length (L) to the orifice diameter (D), that is, L/D, is 40.

### [Math. 1]

SR=K·S [symbol] (II)

[where SR represents shear rate (sec⁻¹), SS represents shear stress (dyn/cm²), and K is a constant] The closer to 1 the N-value, the closer the structure of PPS is to a linear shape. The larger the N-value, the larger the number of branches in the structure of PPS.

Examples of a method for producing the polyarylene sulfide resin include, but are not particularly limited to, the following methods: 1) a method in which a dihalogeno aromatic compound and, as needed, other copolymerization components are polymerized in the presence of sulfur and sodium carbonate; 2) a method in which self-condensation of p-chlorothiophenol and, as needed, other copolymerization components is performed; 3) a method in which a dihalogeno aromatic compound is reacted with a sulfidation agent and, as needed, other copolymerization components in a polar organic solvent; and 4) a method in which melt polymerization of a diiodo aromatic compound, elemental sulfur, and, as needed, a polymerization inhibitor is performed in the presence of a polymerization catalyst. Among the above-described methods, the method 3) is preferably employed because of its versatility. When the reaction is carried out, an alkali-metal salt of a carboxylic acid, an alkali-metal salt of a sulfonic acid, or an alkali hydroxide may be used in order to control the degree of polymerization. Among methods described in 3), the following methods may be particularly preferably employed: a method in which a hydrous sulfidation agent is added to a heated mixture including a polar organic solvent and a dihalogeno aromatic compound at a rate such that water can be removed from the resulting reaction mixture to react the dihalogeno aromatic compound with the sulfidation agent in the polar organic solvent and subsequently the amount of water included in the reaction system is controlled to 0.02 to 0.5 moles per mole of the polar organic solvent in order to produce a PAS resin (see Japanese Unexamined Patent Application Publication 07-228699); and a method in which a polyhaloaromatic compound is reacted with an alkali metal hydrosulfide and an alkali metal salt of an organic acid in the presence of a solid alkali metal sulfide and an aprotic polar organic solvent while the amount of the alkali metal salt of an organic acid is controlled to 0.01 to 0.9 moles per mole of the source of sulfur and the amount of water included in the reaction system is controlled to 0.02 moles per mole of the aprotic polar organic solvent (see WO2010/058713).

In the microporous membrane according to the present invention, the thermoplastic resin has an acicular structure. In order to further enhance the resistance to thermal shrinkage of the microporous membrane, in particular, the aspect ratio of the thermoplastic resin is preferably 1.1 to 100, is more preferably 1.5 to 50, and is particularly preferably 2 to 30. In the thermoplastic resin having an acicular structure, among the long side and the short side, the length of the short side is preferably 10 to 5000 nm, is more preferably 50 to 2000 nm, and is particularly preferably 80 to 500 nm in order to enhance the resistance to thermal shrinkage of the thermoplastic resin and the dispersibility of the thermoplastic resin in the resin composition.

In the present invention, the structure of the thermoplastic resin is determined on the basis of the result of image analysis using a scanning electron microscopy image. Therefore, practically, a thermoplastic resin having a plate-like structure or a rod-like structure may also be considered to be a thermoplastic resin having an acicular structure. Thus, in the present invention, it is assumed that a plate-like structure and a rod-like structure belong to the category of an acicular structure.

Polyolefin

The type of the polyolefin used for producing the microporous membrane according to the present invention is not particularly limited. Examples of such a polyolefin include a homopolymer, a copolymer, and a multi-step polymer that are produced by polymerizing raw materials that are monomers such as ethylene, propylene, butene, methylpentene, hexene, and octene. The above-described homopolymer, copolymer, and multi-step polymer may be used in a mixture of two or more.

For example, in the case where the polyolefin is polyethylene, the mass-average molecular weight of the polyethylene is preferably 5×10⁵ or more and 15×10⁶ or less. Examples of the type of polyethylene include ultra-high-molecular-weight polyethylene, high-density polyethylene, medium-density polyethylene, and low-density polyethylene. In particular, ultra-high-molecular-weight polyethylene is preferably used. The mass-average molecular weight of ultra-high-molecular-weight polyethylene is preferably 1×10⁶ to 15×10⁶ and is more preferably 1×10⁶ to 5×10⁶. Using polyethylene having a mass-average molecular weight of 15×10⁶ or less increases ease of melt extrusion. It is also preferable to mix, with polyethylene having a mass-average molecular weight of 5×10⁵ or more, at least one polymer selected from the group consisting of polyethylene having a mass-average molecular weight equal to or more than 1×10⁴ and less than 5×10⁵, polypropylene having a mass-average molecular weight of 1×10⁴ to 4×10⁶, polybutene-1 having a mass-average molecular weight of 1×10⁴ to 4×10⁶, polyethylene wax having a mass-average molecular weight equal to or more than 1×10³ and less than 1×10⁴, and an ethylene/α-olefin copolymer having a mass-average molecular weight of 1×10⁴ to 4×10⁶.

In the case where the polyolefin is polypropylene, the mass-average molecular weight of polypropylene is preferably, but not particularly limited to, 1×10⁴ to 4×10⁶.

In the case where a polyolefin or, in particular, polyethylene having a mass-average molecular weight of 5×10⁵ or more is used in combination with the ethylene/α-olefin copolymer, examples of an α-olefin that can be suitably used include propylene, butene-1, hexene-1, pentene-1, 4-methylpentene-1, octene, vinyl acetate, methyl methacrylate, and styrene.

Among the above-described polyolefins, high-density polyethylene, ultra-high-molecular-weight polyethylene, and polypropylene are preferably used as the polyolefin (b) in the present invention. In the case where a pore-forming agent (d1) is used for producing the microporous membrane, high-density polyethylene is more preferably used as the polyolefin (b). In the case where a β-phase-nucleating agent (d2) is used for producing the microporous membrane, polypropylene is more preferably used as the polyolefin (b).

In the microporous membrane according to the present invention, the composition ratio between the thermoplastic resin and the polyolefin is not particularly limited as long as the advantageous effect of the present invention is not impaired. However, in order to enhance the dispersibility of the thermoplastic resin in the polyolefin, it is preferable to set the amount of the thermoplastic resin to 1% to 73% by mass and the amount of the polyolefin to 99% to 27% by mass of the total mass of the thermoplastic resin and the polyolefin. It is more preferable to set the amount of the thermoplastic resin to 10% to 60% by mass and the amount of the polyolefin to 90% to 40% by mass of the total mass of the thermoplastic resin and the polyolefin.

Compatibilizer

In the present invention, a compatibilizer may be used as needed. Use of a compatibilizer advantageously enhances the compatibility between the polyolefin and the thermoplastic resin. The compatibilizer is preferably a thermoplastic elastomer including a functional group capable of reacting with the terminal of the thermoplastic resin. The compatibilizer is more preferably a thermoplastic elastomer that has a melting point of 300° C. or less and that is rubber elastic at room temperature. In particular, a thermoplastic elastomer having a glass transition point of −40° C. or less is preferably used from the viewpoints of heat resistance and ease of mixing because it is rubber elastic even at a low temperature. The lower the glass transition point of the thermoplastic elastomer, the more preferably the thermoplastic elastomer is used as a compatibilizer. In general, the glass transition point of the thermoplastic elastomer is preferably −180° C. to −40° C. and is particularly preferably −150° C. to −40° C.

Specific examples of the thermoplastic elastomer which are preferably used in the present invention include thermoplastic elastomers including at least one functional group selected from the group consisting of an epoxy group, an amino group, a hydroxy group, a carboxyl group, a mercapto group, an isocyanate group, a vinyl group, an acid anhydride group, and an ester group. Among the above-described thermoplastic elastomers, thermoplastic elastomers including a functional group derived from a carboxylic acid derivative, such as an epoxy group, an acid anhydride group, a carboxyl group, or an ester group, are particularly preferably used. The thermoplastic elastomers including any of these functional groups are particularly suitably used in the case where the thermoplastic resin is a polyarylene sulfide resin because such thermoplastic elastomers have strong affinity both for the thermoplastic resin and for the polyolefin.

The thermoplastic elastomer that can be used in the present invention is produced by copolymerization of one or more types of α-olefins with a vinyl-polymerizable compound including any of the above-described functional groups. Examples of the α-olefins include α-olefins having 2 to 8 carbon atoms, such as ethylene, propylene, and butene-1. Examples of the vinyl-polymerizable compound including any of the above-described functional groups include α,β-unsaturated carboxylic acids, such as (meth)acrylic acid and a (meth)acrylic acid ester, and alkyl esters thereof; α,β-unsaturated dicarboxylic acids and derivatives thereof, such as unsaturated dicarboxylic acids having 4 to 10 carbon atoms (e.g., maleic acid, fumaric acid, and itaconic acid), monoesters thereof, diesters thereof, and acid anhydrides thereof; and glycidyl (meth)acrylate.

Among the above-described thermoplastic elastomers, an ethylene-propylene copolymer and an ethylene-butene copolymer that include at least one functional group selected from the group consisting of an epoxy group, an amino group, a hydroxy group, a carboxyl group, a mercapto group, an isocyanate group, a vinyl group, an acid anhydride group, and an ester group in the molecules are preferably used. In particular, an ethylene-propylene copolymer and an ethylene-butene copolymer that include a carboxyl group are further preferably used. The above-described thermoplastic elastomers (c1) may be used alone or in combination of two or more.

In the present invention, in the case where a compatibilizer is used, the composition ratio among the above-described thermoplastic resin, the polylefin, and the compatibilizer is not particularly limited as long as the advantageous effect of the present invention is not impaired, but is preferably such that the total mass of the thermoplastic resin and polylefin is 97% to 90% by mass and the amount of the compatibilizer is 3% to 10% by mass of the total mass of the thermoplastic resin, the polylefin, and the compatibilizer. When the composition ratio among the above-described thermoplastic resin, the polyolefin, and the compatibilizer satisfies the above-described conditions, the compatibility of the thermoplastic resin with the polyolefin and the dispersibility of the thermoplastic resin in the polyolefin can be enhanced, even in the case where the proportion of the thermoplastic resin mixed with the polyolefin is high (e.g., 40% to 73% by mass).

Any publicly known and conventional additive, such as a lubricant, an antiblocking agent, an antistatic agent, an antioxidant, a photostabilizer, or a filler, that does not impair the advantageous effect of the present invention may be optionally mixed with the above-described thermoplastic resin, polylefin, and compatibilizer. In particular, since the method for producing a microporous membrane according to the present invention includes a step of melt-kneading the above-described components at a temperature equal to or higher than the melting point of the thermoplastic resin, an antioxidant is preferably mixed with the above-described thermoplastic resin, polyolefin, and compatibilizer in such a manner that the amount of the antioxidant is 0.01 to 5 parts by mass relative to the 100 parts by mass of the polyolefin in order to prevent burn-in of the polyolefin from occurring.

The microporous membrane according to the present invention can be produced by any of the following methods: (Production Method 1) A method for producing a microporous membrane which includes the steps of (1) melt-kneading a thermoplastic resin having a melting point of 220° C. or more (hereinafter, in Production Methods 1 and 2, referred to as “thermoplastic resin (a) having a melting point of 220° C. or more) with a polyolefin (hereinafter, in Production Methods 1 and 2, referred to as “polyolefin (b)”) in an extruder including a die attached to the side thereof at a temperature equal to or higher than the melting point of the thermoplastic resin (a) to prepare a resin composition (hereinafter, in Production Method 1, referred to as “resin composition (α)”), (2) melt-kneading the resin composition (α) with a pore-forming agent (d1) or with a β-phase-nucleating agent (d2) at a temperature higher than the melting point of the thermoplastic resin (a) by 10° C. or more to prepare a melt-kneaded mixture (β), (3) forming the melt-kneaded mixture (β) heated to a temperature higher than the melting point of the thermoplastic resin (a) by 10° C. or more into a sheet to prepare a sheet (γ) including the thermoplastic resin (a) having an acicular structure, and (4) forming pores in the sheet (γ); and (Production Method 2) A method for producing a microporous membrane which includes the steps of (1′) melt-kneading a thermoplastic resin (a) having a melting point of 220° C. or more with a polyolefin (b) in an extruder including a die attached to the side thereof at a temperature higher than the melting point of the thermoplastic resin (a) by 10° C. or more, subsequently drawing the resulting melt-kneaded mixture to form a strand in such a manner that the ratio of the diameter of a die hole to the diameter of the strand is 1.1 or more, and cutting the strand to prepare a resin composition (hereinafter, in Production Method 2, referred to as “resin composition (α′)”) including the thermoplastic resin (a) having an acicular structure, (2′) kneading the resin composition (α′) with a pore-forming agent (d1) or with a β-phase-nucleating agent (d2) at a temperature equal to or higher than the melting point of the polyolefin (b) and equal to or lower than the melting point of the thermoplastic resin (a) to prepare a kneaded mixture (hereinafter, in Production Method 2, referred to as “kneaded mixture (β′)”), (3′) forming the kneaded mixture (β′) heated to a temperature equal to or higher than the melting point of the polyolefin (b) and equal to or lower than the melting point of the thermoplastic resin (a) into a sheet to prepare a sheet (γ) including the thermoplastic resin (a) having an acicular structure, and (4) forming pores in the sheet (γ).

### (Production Method 1)

### Step (1)

The present invention includes a step (1) of melt-kneading a thermoplastic resin (a) having a melting point of 220° C. or more with a polyolefin (b) at a temperature equal to or higher than the melting point of the thermoplastic resin (a) to prepare a resin composition (α).

In the step (1), it is necessary to uniformly disperse the thermoplastic resin (a), the polyolefin (b), and, as needed, other components. Therefore, the above-described components are preferably melt-kneaded at a temperature higher than the melting point of the thermoplastic resin by 10° C. or more, are more preferably melt-kneaded at a temperature higher than the melting point of the thermoplastic resin by 10° C. to 100° C., and are further preferably melt-kneaded at a temperature higher than the melting point of the thermoplastic resin by 20° C. to 50° C.

An apparatus used for performing melt-kneading in the step (1) is preferably, but not particularly limited to, an extruder including a die attached to the side thereof. Melt-kneading is performed in such a manner that the ratio (output rate/screw rotation speed) of the rate (kg/hr) at which the above-described components are output to the speed (rpm) at which a screw rotates is 0.02 to 2.0 (kg/hr/rpm), is preferably 0.05 to 0.8 (kg/hr/rpm), and is further preferably 0.07 to 0.2 (kg/hr/rpm). This enables a sea-island structure morphology in which the thermoplastic resin (a) is uniformly and finely dispersed in the polyolefin (b) serving as a matrix to be formed, which enables a sheet having a uniform thickness to be formed in a sheet-forming step.

In the step (1), the resin composition (a) output from the die after melt-kneading may be shaped into, for example, pellets, a powder, a plate, fibers, a strand, a film, a sheet, a pipe, a hollow body, or a box by a publicly known method, but is preferably shaped into pellets from the viewpoints of ease of handling during storage, transportation, and the like, and ease of uniformly dispersing the resin composition (α) in melt-kneading performed in the step (2).

In the step (1), the charging ratio between the thermoplastic resin (a) and the polyolefin (b) is preferably such that the amount of the thermoplastic resin (a) is 1% to 73% by mass and the amount of the polyolefin (b) is 99% to 27% by mass of the total mass (a+b) of the thermoplastic resin (a) and the polyolefin (b) and is more preferably such that the amount of the thermoplastic resin (a) is 10% to 60% by mass and the amount of the polyolefin (b) is 90% to 40% by mass of the total mass (a+b) of the thermoplastic resin (a) and the polyolefin (b). When the charging ratio between the thermoplastic resin (a) and the polyolefin (b) falls within the above-described ranges, the dispersibility of the thermoplastic resin (a) in the polyolefin (b) may be advantageously enhanced.

In the case where a compatibilizer (c) is further melt-kneaded with the thermoplastic resin (a) and the polyolefin (b) in the step (1), the charging ratio among the thermoplastic resin (a), the polyolefin (b), and the compatibilizer (c) is such that the total mass (a+b) of the thermoplastic resin (a) and the polylefin (b) is 97% to 90% by mass and the amount of the compatibilizer (c) is 3% to 10% by mass of the total mass (a+b+c) of the thermoplastic resin (a), the polylefin (b), and the compatibilizer (c). When the charging ratio among the thermoplastic resin (a), the polyolefin (b), and the compatibilizer (c) falls within the above-described ranges, the compatibility of the thermoplastic resin (a) with the polyolefin (b) and the dispersibility of the thermoplastic resin (a) in the polyolefin (b) may be advantageously enhanced, even in the case where the proportion of the thermoplastic resin (a) mixed with the polyolefin (b) is high (e.g., 40% to 73% by mass).

In the step (1), as components other than the above-described components (a) to (c), a publicly known, conventional additive that does not impair the advantageous effect of the present invention, such as a lubricant, an antiblocking agent, an antistatic agent, an antioxidant, a photostabilizer, or a filler, may be mixed with the components (a) to (c) as needed. In particular, since melt-kneading is performed at a temperature equal to or higher than the melting point of the thermoplastic resin (a) in the step (1), an antioxidant is preferably mixed with the above-described thermoplastic resin, polyolefin, and compatibilizer in such a manner that the amount of the antioxidant is 0.01 to 5 parts by mass relative to the 100 parts by mass of the polyolefin (b) in order to prevent burn-in of the polyolefin from occurring.

### Step (2)

The present invention includes a step (2) of melt-kneading the resin composition (α) with a pore-forming agent (d1) or with a β-phase-nucleating agent (d2) at a temperature higher than the melting point of the thermoplastic resin (a) by 10° C. or more to prepare a melt-kneaded mixture (β).

Pore-Forming Agent (d1)

Any publicly known, conventional pore-forming agent capable of dissolving in a solvent used in the step (4) described below, in which pores are formed in the sheet (γ), can be used as a pore-forming agent (d1). It is preferable to use, for example, microparticles of calcium carbonate as a pore-forming agent (d1). Alternatively, inorganic microparticles such as microparticles of magnesium sulfate, microparticles of calcium oxide, microparticles of calcium hydroxide, and microparticles of silica and solvents that are solid or liquid at room temperature may also be used as a pore-forming agent (d1).

Examples of the solvents that are liquid at room temperature include aliphatic or cyclic hydrocarbons such as nonane, decane, decalin, para-xylene, undecane, dodecane, and liquid paraffin; mineral oil fractions having a boiling point comparable to those of these aliphatic or cyclic hydrocarbons; and phthalic esters that are liquid at room temperature, such as dibutyl phthalate and dioctyl phthalate. It is preferable to use a nonvolatile liquid solvent such as liquid paraffin.

Examples of the solvents that are solid at room temperature include solvents that are solid at room temperature while they become miscible with a polyolefin when being melt-kneaded under heating, such as stearyl alcohol, ceryl alcohol, and paraffin wax. It is preferable to use a solid solvent in combination with a liquid solvent because using a solid solvent alone may cause uneven stretching or the like to occur.

In the case where the pore-forming agent (d1) is used in the step (2), the charging ratio between the resin composition (α) and the pore-forming agent (d1) is preferably such that the amount of the resin composition (α) is 30% to 80% by mass and the amount of the pore-forming agent (d1) is 70% to 20% by mass of the total mass (α+d1) of the resin composition (α) and the pore-forming agent (d1) and is more preferably such that the amount of the resin composition (α) is 50% to 70% by mass and the amount of the pore-forming agent (d1) is 50% to 30% by mass of the total mass (α+d1) of the resin composition (α) and the pore-forming agent (d1).

Addition of the pore-forming agent (d1) may be performed before starting melt-kneading in the step (2) or while melt-kneading is performed in an extruder. However, it is preferable to add the pore-forming agent (d1) before starting melt-kneading in order to dissolve the pore-forming agent (d1) in the mixture to be melt-kneaded. When melt-kneading is performed, it is preferable to use an antioxidant in order to prevent the polyolefin from oxidizing.

β-Phase-Nucleating Agent (d2)

Examples of the β-phase-nucleating agent that can be used in the present invention include, but are not limited to, the following β-phase-nucleating agents. Alternatively, any β-phase-nucleating agent that promotes formation and growth of the β-phase of a polypropylene resin may be used. The above-described β-phase-nucleating agents may be used alone or in a mixture of two or more.

Examples of the β-phase-nucleating agent include amide compound; tetraoxaspiro compounds; quinacridones; iron oxide particles having a nanoscale size; alkali metal salts and alkaline-earth metal salts of a carboxylic acid, such as 1,2-hydroxystearic acid potassium salt, magnesium benzoate, magnesium succinate, and magnesium phthalate; aromatic sulfonic acid compounds such as sodium benzenesulfonate and sodium naphthalenesulfonate; diesters and triesters of a dibasic or tribasic carboxylic acid; phthalocyanine pigments such as phthalocyanine blue; binary compounds of an organic dibasic acid with an oxide, a hydroxide, or a salt of a metal of Group IIA in the periodic table; and compositions including a cyclic phosphorus compound and a magnesium compound. An example of such a β-phase-nucleating agent which is commercially available is a β-phase-nucleating agent “NJSTAR NU-100” produced by New Japan Chemical Co., Ltd. Specific examples of a polypropylene resin including such a β-phase-nucleating agent include polypropylene “Bepol B-022SP” produced by Aristech, polypropylene “Beta(β)-PP BE60-7032” produced by Borealis, and polypropylene “BNX BETAPP-LN” produced by Mayzo.

In the case where the β-phase-nucleating agent (d2) is used in the step (2), the proportion of the β-phase-nucleating agent (d2) added to the resin composition (α) is not particularly limited as long as the advantageous effect of the present invention is not impaired. However, considering the strengths and toughnesses of the sheet and the porous membrane, the amount of the β-phase-nucleating agent (d2) added to the resin composition (α) is preferably 0.0001 to 10 parts by mass, is more preferably 0.001 to 5 parts by mass, and is most preferably 0.01 to 1 part by mass relative to 100 parts by mass of the polyolefin (b) included in the resin composition (α). It is preferable to set the amount of the β-phase-nucleating agent (d2) added to the resin composition (α) to 0.0001 parts by mass or more because, in such a case, the β-phase can be formed and grown and, even when a separator is formed using the resin composition (α), the separator is capable of maintaining β-activity sufficient to achieve a desired air permeability. It is preferable to set the amount of the β-phase-nucleating agent (d2) added to the resin composition (α) to 10 parts by mass or less because, in such a case, bleeding of the β-phase-nucleating agent may be reduced.

Polyolefin (e)

In the step (2), another polyolefin (hereinafter, referred to as “polyolefin (e)”) may optionally be added to the resin composition (α) prepared in the step (1) in order to dilute the resin composition (α). The type of the polyolefin (e) is not limited and may be the same as that of the above-described polyolefin (b).

In the case where the polyolefin (e) is used in the step (2), the proportion of the polyolefin (e) added is preferably such that the amount of the thermoplastic resin (a) is 1% to 73% by mass and the total mass (b+e) of the polyolefin (b) and the polyolefin (e) is 99 to 27 parts by mass of the total mass (a+b+e) of the thermoplastic resin (a), the polyolefin (b), and the polyolefin (e) included in the resin composition (α), is more preferably such that the amount of the thermoplastic resin (a) is 5% to 60% by mass and the total mass (b+e) of the polyolefin (b) and the polyolefin (e) is 95% to 40% by mass of the total mass (a+b+e) of the thermoplastic resin (a), the polyolefin (b), and the polyolefin (e) included in the resin composition (α), and is further preferably such that the amount of the thermoplastic resin (a) is 20% to 40% by mass and the total mass (b+e) of the polyolefin (b) and the polyolefin (e) is 80% to 60% by mass of the total mass (a+b+e) of the thermoplastic resin (a), the polyolefin (b), and the polyolefin (e) included in the resin composition (α).

In the step (2), as needed, a publicly known, conventional additive other than the above-described components (α), (d1) or (d2), and (e) which does not impair the advantageous effect of the present invention, such as a lubricant, an antiblocking agent, an antistatic agent, an antioxidant, a photostabilizer, a crystal-nucleating agent, or a filler, may be mixed with the above-described components (α), (d1) or (d2), and (e).

In the step (2), melt-kneading is preferably performed at a temperature higher than the melting point of the thermoplastic resin by 10° C. or more, is more preferably performed at a temperature higher than the melting point of the thermoplastic resin by 10° C. to 100° C., and is further preferably performed at a temperature higher than the melting point of the thermoplastic resin by 20° C. to 50° C.

A method for performing melt-kneading in the step (2) is not particularly limited, but it is preferable to perform kneading uniformly in an extruder. It is more preferable to perform kneading in an extruder including a die for forming sheets, such as a T-die, attached to the side thereof in order to conduct the subsequent step (3).

In the step (2), melt-kneading is preferably performed in such a manner that the ratio (output rate/screw rotation speed) of the rate (kg/hr) at which the above-described components are output to the speed (rpm) at which a screw rotates is 0.02 to 2.0 (kg/hr/rpm). The ratio (output rate/screw rotation speed) is more preferably 0.05 to 0.8 (kg/hr/rpm) and is further preferably 0.07 to 0.2 (kg/hr/rpm). This enables a sea-island structure morphology in which the pore-forming agent (d1) or β-phase-nucleating agent (d2) is uniformly and finely dispersed to be formed when the thermoplastic resin (a) and the pore-forming agent (d1) or β-phase-nucleating agent (d2) are added to a matrix, that is, the polyolefin (b) and the polyolefin (e), which enables a sheet having a uniform thickness to be formed in a sheet-forming step and a microporous membrane in which pores having a very small diameter are uniformly distributed to be formed.

After melt-kneading is performed in the step (2), the melt-kneaded mixture (β) may be shaped into, for example, pellets, a powder, a plate, fibers, a strand, a film, a sheet, a pipe, a hollow body, or a box, or may be temporarily cooled and subsequently shaped into pellets. However, from the viewpoint of productivity, it is preferable to perform melt-kneading in an extruder including a T-die attached to the side thereof and conduct the subsequent step (3) directly or using another extruder.

### Step (3)

The present invention includes a step (3) of forming the melt-kneaded mixture (β) heated to a temperature higher than the melting point of the thermoplastic resin (a) by 10° C. or more into a sheet to prepare a sheet (γ).

In the step (3), it is preferable, after the melt-kneaded mixture (β) is temporarily cooled and subsequently shaped into, for example, pellets, to extrude the melt-kneaded mixture (β) from the die directly or using the extruder or another extruder and subsequently draw the melt-kneaded mixture (β) using a roller such as a cast roller or a roll drawing machine in such a manner that the ratio of the gap of a lip portion of the die (lip width) to the thickness of the sheet is 1.1 to 40. The ratio of the lip width to the thickness of the sheet is more preferably 2 to 20. In general, the die is preferably a die for forming sheets which has a rectangular sleeve. Alternatively, a double cylindrical, hollow die, an inflation die, or the like may also be used. In the case where a die for forming sheets is used, generally, the gap of a lip portion of the die (lip width) is preferably 0.1 to 5 mm. When extrusion is performed, the die is heated to a temperature higher than the melting point of the thermoplastic resin (a) by 10° C. or more, is more preferably heated to a temperature higher than the melting point of the thermoplastic resin by 10° C. to 100° C., and is further preferably heated to a temperature higher than the melting point of the thermoplastic resin by 20° C. to 50° C. The rate of extruding the heated solution is preferably 0.2 to 50 (m/min).

The melt-kneaded mixture (β) extruded from the die in the above-described manner is cooled to form a sheet (γ). The cooling rate is preferably 50° C./min or more at least until the gelation temperature is reached. It is preferable to cool the melt-kneaded mixture (β) to 25° C. or less. This enables a phase including the polyolefin to gelate and a phase-separation structure in which the thermoplastic resin (a) is dispersed in the polyolefin phase to be immobilized. If the cooling rate is less than 50° C./min, the degree of crystallinity is increased, which may reduce the stretchability of the resulting sheet. The melt-kneaded mixture (β) can be cooled by, for example, being brought into direct contact with a cooling medium such as cold air, cooling water, or the like or by being brought into contact with a roller cooled using a coolant. The draft ratio ((roll drawing speed)/(flow rate of the resin discharged through the die lip, which is calculated by converting the density of the resin)) at which the melt-kneaded mixture (β) is drawn using a roller is preferably 1 to 600 times, is more preferably 1 to 200 times, and is further preferably 1 to 100 times from the viewpoints of air permeability and formability.

At this time, in the case where the pore-forming agent (d1) is used, the melt-kneaded mixture (β) is preferably cooled to 25° C. or less. In the case where the β-phase-nucleating agent (d2) is used, the melt-kneaded mixture (β) is preferably cooled to 80° C. to 150° C. and is further preferably cooled to 90° C. to 140° C. in order to control the proportion of the β-phase of the polyolefin (b) to 20% to 100% or preferably 50% to 100%. Note that the term “proportion of the β-phase” used herein refers to proportion (%) calculated by [ΔHmβ/(ΔHmβ+ΔHmα)]×100(%) from the amount of heat (ΔHmα) required to melt a crystal which is derived from the α-phase of the polyolefin (b) and the amount of heat (ΔHmβ) required to melt a crystal which is derived from the β-phase of the polyolefin (b), which are detected by differential scanning calorimetry while the membrane-like product is heated from 25° C. to 240° C. at a heating rate of 10° C./min.

### Step (4)

The present invention includes a step (4) of forming pores in the sheet (γ) prepared in the step (3).

The step (4), that is, a pore-forming step, greatly varies depending on whether the pore-forming agent (d1) is used or whether the β-phase-nucleating agent (d2) is used. First, the case where the pore-forming agent (d1) is used is described below.

In the case where the pore-forming agent (d1) is used, the step (4) is a step in which the pore-forming agent (d1) is eluted using an acidic aqueous solution to form micropores, that is, a step of forming a microporous membrane by a “wet process”. Specific examples of the step (4) include a step (4a) in which the pore-forming agent (d1) is removed from the sheet (γ) after the sheet (γ) is stretched, a step (4b) in which the sheet (γ) is stretched after the pore-forming agent (d1) is removed from the sheet (γ), and a step (4c) in which the pore-forming agent (d1) is removed from the sheet (γ) after the sheet (γ) is stretched, and subsequently the sheet (γ) is further stretched.

In any of the steps (4a) to (4c), after the sheet (γ) is heated, the sheet (γ) is stretched by an ordinary tenter method, a roll method, an inflation method, or a rolling method or by using these methods in combination at a predetermined extension ratio. The sheet (γ) may be stretched by uniaxial stretching or biaxial stretching, but is preferably stretched by biaxial stretching. In the case where biaxial stretching is employed, The sheet (γ) may be stretched by simultaneous biaxial stretching, successive stretching, or multi-step stretching (i.e., using simultaneous biaxial stretching and successive stretching in combination). In particular, it is preferable to employ successive biaxial stretching. Stretching the sheet (γ) increases the mechanical strength of the sheet (γ).

The extension ratio varies depending on the thickness of the sheet (γ). In the case where uniaxial stretching is employed, the extension ratio is preferably 2 times or more and is more preferably 3 to 30 times. In the case where biaxial stretching is employed, the extension ratio is preferably at least 2 times or more in both directions, that is, 4 times or more in terms of area expansion ratio. The extension ratio is more preferably set in such a manner that the area expansion ratio is 6 times or more. When the area expansion ratio is 4 times or more, the piercing strength of the sheet (γ) can be increased. However, if the area expansion ratio exceeds 100 times, limitations may be imposed on, for example, a stretching machine or stretching operation.

In the case where the polyolefin is a homopolymer, the sheet (γ) is preferably stretched at a temperature equal to or lower than the temperature higher than the melting point of the polyolefin by 10° C. and is more preferably stretched at a temperature equal to or higher than the crystal dispersion temperature and lower than the crystal melting point. If the stretching temperature exceeds the temperature higher than the melting point of the polyolefin by 10° C., the polyolefin becomes molten and it is impossible to align the molecular chains by stretching the sheet (γ). If the stretching temperature is lower than the crystal dispersion temperature, it becomes impossible to softening the polyolefin to a sufficient degree, which makes the sheet (γ) susceptible to breakage while being stretched. In such a case, it is impossible to stretch the sheet (γ) at a high extension ratio. However, in the case where successive stretching or multi-step stretching is performed, the first stretching may be performed at a temperature lower than the crystal dispersion temperature. Note that the “crystal dispersion temperature” used herein refers to temperature determined by measuring the temperature characteristics of dynamic viscoelasticity conforming to ASTM D 4065. The crystal dispersion temperature of polyethylene is generally 90° C.

In the case where the polyolefin includes polyethylene, the stretching temperature is preferably equal to or higher than the crystal dispersion temperature of the polyethylene and equal to or lower than the temperature higher than the crystal melting point of the polyethylene by 10° C. In the case where the polyolefin is polyethylene or a composition including polyethylene, in the present invention, normally, the stretching temperature is preferably set to 100° C. to 130° C. and is more preferably set to 110° C. to 120° C.

Depending on the desired physical properties, optionally, the sheet (γ) may be stretched with a temperature distribution in the thickness direction or may be subjected to successive stretching or multi-step stretching, in which the first stretching is performed at a relatively low temperature and subsequently the second stretching is performed at a high temperature. In general, stretching the sheet (γ) with a temperature distribution in the thickness direction enables a microporous membrane having high mechanical strength to be formed. For example, the method disclosed in Japanese Unexamined Patent Application Publication No. 7-188440 may be employed.

The pore-forming agent (d1) is removed using a solvent (hereinafter, referred to as “removal solvent”) capable of dissolving the pore-forming agent (d1). By removing the uniformly finely dispersed pore-forming agent (d1) using the removal solvent, a porous membrane is formed. Specific examples of the removal solvent include the following highly volatile solvents: acidic aqueous solutions such as hydrochloric acid; chlorinated hydrocarbons such as methylene chloride and carbon tetrachloride; hydrocarbons such as pentane, hexane, and heptane; fluorohydrocarbons such as trifluoroethane; ethers such as diethyl ether and dioxane; and methyl ethyl ketone. Another example of the removal solvent is the solvent disclosed in Japanese Unexamined Patent Application Publication No. 2002-256099, which has a surface tension of 24 mN/m or less at 25° C. Using such a solvent having a certain surface tension prevents shrinkage densification of a network structure which is caused by the surface tension at the gas-liquid interface created inside the micropores when the sheet (γ) is dried after the pore-forming agent (d1) is removed from the sheet (γ) from occurring. This further enhances the porosity and permeability of the microporous membrane.

The pore-forming agent (d1) may be removed from the sheet (γ) by, for example, immersing the stretched membrane or the sheet (γ) in the removal solvent, by showering the removal solvent on the stretched membrane or the sheet (γ), or by using these methods in combination. The amount of the removal solvent used is preferably 300 to 30000 parts by mass relative to 100 parts by mass of the sheet (γ). The removal treatment using the removal solvent is preferably continued until the amount of the remaining pore-forming agent reaches less than 1% by mass of the amount of the pore-forming agent that has been added originally.

In the case where the β-phase-nucleating agent (d2) is used, the step (4) is a step in which a sheet including a polyolefin including the β-phase or, particularly preferably, a sheet including a polypropylene resin is stretched to form micropores, that is, a method for forming a microporous membrane by “dry process”. An example of the step (4) is a step (4d) of stretching the sheet (γ).

In the step (4d), after the sheet (γ) is heated, the sheet (γ) is stretched by an ordinary tenter method, a roll method, an inflation method, or a rolling method or by using these methods in combination at a predetermined extension ratio. The sheet (γ) may be stretched by uniaxial stretching or biaxial stretching, but is preferably stretched by biaxial stretching. In the case where biaxial stretching is employed, the sheet (γ) may be stretched by simultaneous biaxial stretching, successive stretching, or multi-step stretching (i.e., using simultaneous biaxial stretching and successive stretching in combination). In particular, it is preferable to employ successive biaxial stretching. Stretching the sheet (γ) increases the mechanical strength of the sheet (γ).

The extension ratio varies depending on the thickness of the sheet (γ). In the case where uniaxial stretching is employed, the extension ratio is preferably 2 times or more and is more preferably 3 to 30 times. In the case where biaxial stretching is employed, the extension ratio is preferably at least 2 times or more in both directions, that is, 4 times or more in terms of area expansion ratio. The extension ratio is more preferably set in such a manner that the area expansion ratio is 6 times or more. When the area expansion ratio is 4 times or more, the piercing strength of the sheet (γ) can be increased. However, if the area expansion ratio exceeds 100 times, limitations may be imposed on, for example, a stretching machine or stretching operation.

In the case where the β-phase-nucleating agent (d2) is used, in the stretching step, the sheet (γ) may be uniaxially stretched in the longitudinal direction or in the transverse direction or may be biaxially stretched. In the case where the sheet (γ) is biaxially stretched, simultaneous biaxial stretching and successive biaxial stretching may be employed. In order to prepare the polyolefin resin porous film according to the present invention, successive biaxial stretching is more preferably employed because successive biaxial stretching allows stretching conditions to be changed in each stretching step and enables a porous structure to be readily controlled.

In the case where successive biaxial stretching is employed, it is necessary to change the stretching temperature appropriately depending on the composition, crystal melting peak temperature, degree of crystallinity, and the like of the resin composition used. When longitudinal stretching is performed, the stretching temperature is preferably controlled to about 0° C. to about 130° C., is more preferably about 10° C. to about 120° C., and is further preferably about 20° C. to about 110° C. The longitudinal extension ratio is preferably 2 to 10 times, is more preferably 3 to 8 times, and is further preferably 4 to 7 times. Performing longitudinal stretching within the above-described ranges reduces the risk of breakage of the sheet (γ) which occurs while the sheet (γ) is stretched and enables adequate origins of pores to be created.

When transverse stretching is performed, the stretching temperature is set to about 100° C. to about 160° C., is preferably set to about 110° C. to about 150° C., and is further preferably set to about 120° C. to about 140° C. The transverse extension ratio is preferably 2 to 10 times, is more preferably 3 to 8 times, and is further preferably 4 to 7 times. Performing transverse stretching within the above-described ranges adequately enlarges the origins of pores created by longitudinal stretching to form a fine porous structure.

The stretching rate in the stretching step is preferably 500 to 12000%/min, is further preferably 1500 to 10000%/min, and is further preferably 2500 to 8000%/min.

Other Treatment Steps

The membrane prepared through the step (4) may optionally be subjected to publicly known post-treatment steps such as a drying treatment, a heating treatment, a crosslinking treatment, and a hydrophilicity-imparting treatment.

The drying treatment may be performed by, for example, heat-drying or air-drying. The drying temperature is preferably equal to or lower than the crystal dispersion temperature of the polyolefin and is particularly preferably lower than the crystal dispersion temperature of the polyolefin by 5° C. or more.

Through the drying treatment, the content of the removal solvent remaining in the microporous membrane is preferably reduced to 5% by mass or less (based on 100% by mass of the mass of the membrane after drying) and is more preferably reduced to 3% by mass or less. If a large mount of removal solvent remains in the membrane due to insufficient drying, the porosity of the membrane may be reduced in the subsequent heating treatment, which deteriorates the permeability of the membrane.

In the present invention, it is preferable to perform a heating treatment as a post-treatment. Through a heating treatment, the crystal is stabilized and a uniform lamellar layer can be formed. The heating treatment may be any of a hot-stretching treatment, a heat-setting treatment, and a heat-shrinkage treatment, which is selected appropriately depending on the physical properties required for the microporous membrane. The heating treatment is preferably performed at a temperature equal to or higher than the crystallization temperature of the polyolefin included in the microporous membrane and equal to or lower than the melting point of the polyolefin and is more preferably performed at a temperature intermediate between the crystallization temperature and melting point of the polyolefin.

The hot-stretching treatment is performed by an ordinary tenter method, a roll method, or a rolling method. It is preferable to stretch the microporous membrane in at least one direction at an extension ratio of 1.01 to 2.0 times. It is more preferable to set the extension ratio to 1.01 to 1.5 times.

The heat-setting treatment is performed by a tenter method, a roll method, or a rolling method. The heat-shrinkage treatment is performed by a tenter method, a roll method, or a rolling method. Alternatively, the heat-shrinkage treatment may be performed using a belt conveyor or a floating. It is preferable to perform the heat-shrinkage treatment in at least one direction at 50% or less. It is preferable to set the ratio to 30% or less.

The above-described hot-stretching treatment, heat-setting treatment, and heat-shrinkage treatment may be performed in combination successively. In particular, performing the hot-stretching treatment after the heat-setting treatment enhances the permeability of the microporous membrane to be produced and increases the diameter of pores. Performing the heat-shrinkage treatment after the hot-stretching treatment enables a microporous membrane having a low shrinkage ratio and a high strength to be produced.

The crosslinking treatment is performed using ionizing radiation such as α-rays, β-rays, γ-rays, or electron beam. The ionizing radiation is performed at an electron dose of 0.1 to 100 Mrad and an accelerating voltage of 100 to 300 kV to form crosslinks in the microporous membrane. This increases the meltdown temperature of the microporous membrane.

In the hydrophilicity-imparting treatment, monomer grafting, a surfactant treatment, a corona discharge treatment, or the like is performed to impart hydrophilicity to the microporous membrane. It is preferable to perform the monomer graft treatment after the ionizing radiation.

In the case where the hydrophilicity-imparting treatment is performed by a surfactant treatment using a surfactant, the surfactant may be any of a nonionic surfactant, a cationic surfactant, an anionic surfactant, and an amphoteric surfactant, but is preferably a nonionic surfactant. When the surfactant is used, the surfactant is formed into an aqueous solution or into a solution in a lower alcohol such as methanol, ethanol, or isopropyl alcohol and the hydrophilicity-imparting treatment is performed by dipping or a method using a doctor blade. After being subjected to the hydrophilicity-imparting treatment, the microporous membrane is dried. At this time, in order to enhance the permeability of the microporous membrane, the microporous membrane is preferably subjected to a heating treatment while maintaining a temperature equal to or lower than the melting point of the microporous membrane in order to prevent the microporous membrane from shrinking. It is possible to perform the heating treatment while preventing the microporous membrane from shrinking by, for example, heating the microporous membrane while stretching the microporous membrane.

The microporous membrane according to the present invention may optionally be subjected to a publicly known surface treatment using a corona treatment machine, a plasma treatment machine, an ozone treatment machine, a flame treatment machine, or the like.

### (Production Method 2)

### Step (1′)

The present invention includes a step (1′) of melt-kneading a thermoplastic resin (a) having a melting point of 220° C. or more with a polyolefin (b) in an extruder including a die attached to the side thereof at a temperature equal to or higher than the melting point of the thermoplastic resin (a), drawing the melt-kneaded mixture to form a strand in such a manner that the ratio of the diameter of a die hole to the diameter of the strand is 1.1 or more, and cutting the strand to prepare a resin composition (α′) including a thermoplastic resin (a) having an acicular structure.

In the step (1′), it is necessary to uniformly disperse the thermoplastic resin (a), the polyolefin (b), and, as needed, other components. Therefore, melt-kneading is preferably performed at a temperature higher than the melting point of the thermoplastic resin by 10° C. or more, is more preferably performed at a temperature higher than the melting point of the thermoplastic resin by 10° C. to 100° C., and is further preferably performed at a temperature higher than the melting point of the thermoplastic resin by 20° C. to 50° C.

An apparatus used for performing melt-kneading in the step (1′) is preferably an extruder including a die attached to the side thereof. Melt-kneading is preferably performed in such a manner that the ratio (output rate/screw rotation speed) of the rate (kg/hr) at which the above-described components are output to the speed (rpm) at which a screw rotates is 0.02 to 2.0 (kg/hr/rpm). The ratio (output rate/screw rotation speed) is more preferably 0.05 to 0.8 (kg/hr/rpm) and is further preferably 0.07 to 0.2 (kg/hr/rpm). This enables a sea-island structure morphology in which the thermoplastic resin (a) is uniformly and finely dispersed in the polyolefin (b) serving as a matrix to be formed, which enables a sheet having a uniform thickness to be formed in a sheet-forming step.

After melt-kneading is performed in the step (1′), the melt-kneaded mixture is drawn to form a strand in such a manner that the ratio of the diameter of a die hole to the diameter of the strand is preferably 1.1 or more, is more preferably 1.1 to 3, and is further preferably 1.5 to 2. Subsequently, the strand is cut by a publicly known method and then shaped into, for example, pellets, a powder, a plate, fibers, a strand, a film, a sheet, a pipe, a hollow body, or a box. Thus, a resin composition (α′) including the thermoplastic resin (a) having an acicular structure can be prepared. The resin composition (α′) preferably has a pellet-like shape from the viewpoints of ease of handling during storage, transportation, and the like, and ease of uniformly dispersing the resin composition (α′) in melt-kneading performed in the step (2′). Note that the term “diameter of a die hole” used herein refers to the diameter of the output nozzle of the die.

In the step (1′), the charging ratio between the thermoplastic resin (a) and the polyolefin (b) is preferably such that the amount of the thermoplastic resin (a) is 1% to 73% by mass and the amount of the polyolefin (b) is 99% to 27% by mass of the total mass (a+b) of the thermoplastic resin (a) and the polyolefin (b) and is more preferably such that the amount of the thermoplastic resin (a) is 10% to 60% by mass and the amount of the polyolefin (b) is 90% to 40% by mass of the total mass (a+b) of the thermoplastic resin (a) and the polyolefin (b). When the charging ratio between the thermoplastic resin (a) and the polyolefin (b) falls within the above-described ranges, the dispersibility of the thermoplastic resin (a) in the polyolefin (b) may be advantageously enhanced.

In the case where a compatibilizer (c) is further melt-kneaded with the thermoplastic resin (a) and the polyolefin (b) in the step (1′), the proportion of the compatibilizer (c) charged is such that the total mass (a+b) of the thermoplastic resin (a) and the polylefin (b) is 97% to 90% by mass and the amount of the compatibilizer (c) is 3% to 10% by mass of the total mass (a+b+c) of the thermoplastic resin (a), the polylefin (b), and the compatibilizer (c). When the proportion of the compatibilizer (c) charged falls within the above-described ranges, the compatibility of the thermoplastic resin (a) with the polyolefin (b) and the dispersibility of the thermoplastic resin (a) in the polyolefin (b) may be advantageously enhanced, even in the case where the proportion of the thermoplastic resin (a) mixed with the polyolefin (b) is high (e.g., 40% to 73% by mass).

In the step (1′), optionally, as components other than the above-described components (a) to (c), a publicly known, conventional additive that does not impair the advantageous effect of the present invention, such as a lubricant, an antiblocking agent, an antistatic agent, an antioxidant, a photostabilizer, or a filler, may be mixed with the components (a) to (c). In particular, since melt-kneading is performed at a temperature equal to or higher than the melting point of the thermoplastic resin (a) in the step (1′), an antioxidant is preferably mixed with the above-described thermoplastic resin, polyolefin, and compatibilizer in such a manner that the amount of the antioxidant is 0.01 to 5 parts by mass relative to the 100 parts by mass of the polyolefin (b) in order to prevent burn-in of the polyolefin from occurring.

### Step (2′)

The present invention includes a step (2′) of kneading the resin composition (α′) prepared in the step (1′) with a pore-forming agent (d1) or with a β-phase-nucleating agent (d2) at a temperature equal to or higher than the melting point of the polyolefin (b) and equal to or lower than the melting point of the thermoplastic resin (a), that is, kneading the molten polyolefin (b) with the thermoplastic resin (a) having an acicular structure, to prepare a melt-kneaded mixture (β′).

Pore-Forming Agent

The pore-forming agent (d1) may be the same as that used in the above-described Production Method 1.

In the case where the pore-forming agent (d1) is used in the step (2′), the charging ratio between the resin composition (α′) and the pore-forming agent (d1) is preferably such that the amount of the resin composition (α′) is 30% to 80% by mass and the amount of the pore-forming agent (d1) is 70% to 20% by mass of the total mass (α′+d1) of the resin composition (α′) and the pore-forming agent (d1) and is more preferably such that the amount of the resin composition (α′) is 50% to 70% by mass and the amount of the pore-forming agent (d1) is 50% to 30% by mass of the total mass (α′+d1) of the resin composition (α′) and the pore-forming agent (d1).

Addition of the pore-forming agent (d1) may be performed before starting kneading in the step (2′) or while kneading is performed in an extruder. However, it is preferable to add the pore-forming agent (d1) before starting kneading in order to dissolve the pore-forming agent (d1) in the mixture to be melt-kneaded. When kneading is performed, it is preferable to use an antioxidant in order to prevent the polyolefin from oxidizing.

β-Phase-Nucleating Agent (d2)

The β-phase-nucleating agent that can be used in the present invention may be the same as that used in the Production Method 1.

In the case where the β-phase-nucleating agent (d2) is used in the step (2′), the proportion of the β-phase-nucleating agent (d2) added to the resin composition (α′) is not particularly limited as long as the advantageous effect of the present invention is not impaired. However, considering the strengths and toughnesses of the sheet and the porous membrane, the amount of the β-phase-nucleating agent (d2) added to the resin composition (α′) is preferably 0.0001 to 10 parts by mass, is more preferably 0.001 to 5 parts by mass, and is most preferably 0.01 to 1 part by mass relative to 100 parts by mass of the polyolefin (b) included in the resin composition (α′). It is preferable to set the amount of the β-phase-nucleating agent (d2) added to the resin composition (α′) to 0.0001 parts by mass or more because, in such a case, the β-phase can be formed and grown and, even when a separator is formed using the resin composition (α′), the separator is capable of maintaining β-activity sufficient to achieve a desired air permeability. It is preferable to set the amount of the β-phase-nucleating agent (d2) added to the resin composition (α′) to 10 parts by mass or less because, in such a case, bleeding of the β-phase-nucleating agent may be reduced.

Polyolefin (e)

In the step (2′), another polyolefin may be added to the resin composition (α′) prepared in the step (1′) to dilute the resin composition (α′).

In the case where the polyolefin (e) is used in the step (2′), the proportion of the polyolefin (e) charged is preferably such that the amount of the thermoplastic resin (a) is 1% to 73% by mass and the total mass (b+e) of the polyolefin (b) and the polyolefin (e) is 99 to 27 parts by mass of the total mass (a+b+e) of the thermoplastic resin (a), the polyolefin (b), and the polyolefin (e) included in the resin composition (α′), is more preferably such that the amount of the thermoplastic resin (a) is 5% to 60% by mass and the total mass (b+e) of the polyolefin (b) and the polyolefin (e) is 95% to 40% by mass of the total mass (a+b+e) of the thermoplastic resin (a), the polyolefin (b), and the polyolefin (e) included in the resin composition (α′), and is further preferably such that the amount of the thermoplastic resin (a) is 20% to 40% by mass and the total mass (b+e) of the polyolefin (b) and the polyolefin (e) is 80% to 60% by mass of the total mass (a+b+e) of the thermoplastic resin (a), the polyolefin (b), and the polyolefin (e) included in the resin composition (α′).

In the step (2′), as needed, a publicly known, conventional additive other than the above-described components (α′), (d), and (e) which does not impair the advantageous effect of the present invention, such as a lubricant, an antiblocking agent, an antistatic agent, an antioxidant, a photostabilizer, a crystal-nucleating agent, or a filler, may be mixed with the above-described components (α′), (d), and (e).

In the step (2′), in order to knead the molten polyolefin (b) with the thermoplastic resin (a) having an acicular structure, kneading is performed at a temperature equal to or higher than the melting point of the polyolefin (b) and equal to or lower than the melting point of the thermoplastic resin (a) and is preferably performed at a temperature higher than the melting point of the polyolefin (b) by 10° C. or more and lower than the melting point of the thermoplastic resin (a) by 10° C. or more. In the case where the polyolefin (e) is added to the resin composition (α′), kneading is performed at a temperature equal to or higher than the higher melting point among those of the polyolefin (b) and the polyolefin (e) and is preferably performed at a temperature higher than the higher melting point among those of the polyolefin (b) and the polyolefin (e) by 10° C. or more and lower than the melting point of the thermoplastic resin (a) by 10° C. or more.

A method for performing kneading in the step (2′) is not particularly limited, but it is preferable to perform kneading uniformly in an extruder. It is more preferable to perform kneading in an extruder including a die for forming sheets, such as a T-die, attached to the side thereof in order to conduct the subsequent step (3).

In the step (2′), kneading is preferably performed in such a manner that the ratio (output rate/screw rotation speed) of the rate (kg/hr) at which the above-described components are output to the speed (rpm) at which a screw rotates is 0.02 to 2.0 (kg/hr/rpm). The ratio (output rate/screw rotation speed) is more preferably 0.05 to 0.8 (kg/hr/rpm) and is further preferably 0.07 to 0.2 (kg/hr/rpm). This enables a sea-island structure morphology in which the pore-forming agent (d1) or β-phase-nucleating agent (d2) is uniformly and finely dispersed to be formed when the thermoplastic resin (a) and the pore-forming agent (d1) or β-phase-nucleating agent (d2) are added to a matrix, that is, the polyolefin (b) and the polyolefin (e), which enables a sheet having a uniform thickness to be formed in a sheet-forming step and a microporous membrane in which pores having a very small diameter are uniformly distributed to be formed.

After melt-kneading is performed in the step (2′), the melt-kneaded mixture (β′) may be shaped into, for example, pellets, a powder, a plate, fibers, a strand, a film, a sheet, a pipe, a hollow body, or a box, or may be temporarily cooled and subsequently shaped into pellets. However, from the viewpoint of productivity, it is preferable to perform melt-kneading in an extruder including a T-die attached to the side thereof and to conduct the subsequent step (3′) directly or using another extruder.

### Step (3′)

The present invention includes a step (3′) of forming the kneaded mixture (β′) heated to a temperature equal to or higher than the melting point of the polyolefin (b) into a sheet to prepare a sheet (γ) including the thermoplastic resin (a) having an acicular structure.

After the melt-kneaded mixture (β′) is temporarily cooled and subsequently shaped into, for example, pellets, the melt-kneaded mixture (β′) is extruded from the die directly or using the extruder or another extruder. Subsequently, the melt-kneaded mixture (β′) is drawn using a roller such as a cast roller or a roll drawing machine. In general, the die is preferably a die for forming sheets which has a rectangular sleeve. Alternatively, a double cylindrical, hollow die, an inflation die, or the like may also be used. In the case where a die for forming sheets is used, normally, the gap of the die is preferably 0.1 to 5 mm. When extrusion is performed, the die is preferably heated to a temperature equal to or higher than the melting point of the polyolefin (b) and equal to or lower than the melting point of the thermoplastic resin (a) and is more preferably heated to a temperature higher than the melting point of the polyolefin (b) by 10° C. or more and lower than the melting point of the thermoplastic resin (a) by 10° C. or more. In the case where the polyolefin (e) is added to the resin composition (α′), the die is heated to a temperature equal to or higher than the higher melting point among those of the polyolefin (b) and the polyolefin (e) and is preferably heated to a temperature higher than the higher melting point among those of the polyolefin (b) and the polyolefin (e) by 10° C. or more and lower than the melting point of the thermoplastic resin (a) by 10° C. or more. Specifically, it is preferable to heat the die to 140° C. to 250° C. The heated solution is preferably extruded at a rate of 0.2 to 15 (m/min).

The melt-kneaded mixture (β′) extruded from the die in the above-described manner is cooled to form a sheet (γ). The cooling rate is preferably 50° C./min or more at least until the gelation temperature is reached. It is preferable to cool the melt-kneaded mixture (β′) to 25° C. or less. This enables a phase including the polyolefin to gelate and a phase-separation structure in which the thermoplastic resin (a) is dispersed in the polyolefin phase to be immobilized. If the cooling rate is less than 50° C./min, the degree of crystallinity is increased, which may reduce the stretchability of the sheet. The melt-kneaded mixture (β′) can be cooled by, for example, being brought into direct contact with a cooling medium such as cold air, cooling water, or the like or by being brought into contact with a roller cooled using a coolant. The draft ratio ((roll drawing speed)/(flow rate of the resin discharged through the die lip, which is calculated by converting the density of the resin)) at which the melt-kneaded mixture (β′) is drawn using a roller is preferably 10 to 600 times, is more preferably 20 to 500 times, and is further preferably 30 to 400 times from the viewpoints of air permeability and formability.

At this time, in the case where the pore-forming agent (d1) is used, the kneaded mixture (β′) is preferably cooled to 25° C. or less. In the case where the β-phase-nucleating agent (d2) is used, the kneaded mixture (β′) is preferably cooled to 80° C. to 150° C. and is further preferably cooled to 90° C. to 140° C. in order to control the proportion of the β-phase of the polyolefin (b) to 20% to 100% or preferably 50% to 100%.

The step (4) and the subsequent other treatment steps may be performed as in Production Method 1.

### <Microporous Membrane>

The microporous membrane according to the present invention is produced by, in any of the above-described Production Methods 1 and 2, melt-kneading the thermoplastic resin (a) and the polyolefin at a temperature higher than the melting point of the thermoplastic resin (a) by 10° C. or more and then applying a stress to the polyolefin and the thermoplastic resin (a) in a molten state to make the thermoplastic resin (a) acicular. The microporous membrane according to the present invention includes a polyolefin serving as a matrix and a thermoplastic resin (a) having an acicular structure which is dispersed uniformly in the polyolefin. It is preferable to form a morphology in which the matrix and the thermoplastic resin (a) having an acicular structure are in intimate contact with each other at the interface therebetween in order to reduce the thermal shrinkage of the microporous membrane and to further enhance resistance to thermal shrinkage.

The microporous membrane according to the preferred embodiment of the present invention has the following physical properties:

(1) the thickness of the microporous membrane produced by the production method according to the present invention is generally 5 to 50 μm, is more preferably 8 to 40 μm, and further preferably 10 to 30 μm, but is not particularly limited and may be any thickness between 5 to 200 μm as required by the application.

(2) a Gurley air permeability of 50 to 800 s/100 ml.

(3) a shut-down temperature of 130° C. to 150° C.

In order to produce the above-described microporous membrane, the sheet material, which is an intermediate material in which micropores have not yet been formed, requires the following properties:

(4) a thermal shrinkage ratio at 200° C. of 30% or less when measured before heat-setting and 25% or less when measured after heat-setting.

(5) a mechanical strength, for example, tensile strength, of 20 MPa or more.

(6) small unevenness in the thickness of the sheet which prevents the breakage of the sheet from occurring when the sheet is hot-stretched.

The microporous membrane according to the present invention has high resistance to compression, high heat resistance, and high permeability in a balanced manner. Therefore, the microporous membrane according to the present invention can be suitably used as a battery separator for nonaqueous-electrolyte-type secondary batteries such as a lithium ion secondary battery and is more suitably used as a single-layer battery separator for nonaqueous-electrolyte-type secondary batteries.

### EXAMPLES

The present invention is described further in detail with reference to Examples below, which do not limit the present invention.

Sheets each having a specific composition that does not include a pore-forming-agent (d1)-component were prepared in the following manner. The thermal shrinkage ratio and mechanical strength of each sheet were measured by the following method. Thus, the properties of each sheet, which vary depending on simply the composition of the resin composition (α) but not on the factors of the type and amount of the pore-forming agent (d1) used nor on the structural factors of the shape and density of the micropores formed using the pore-forming agent, were evaluated.

### Examples 1 to 8 and Comparative Examples 1 to 3

The polyphenylene sulfide resin, the polyolefin resin-1, and the thermoplastic elastomer shown in Tables 1 to 3 below were uniformly mixed together in a tumbler to prepare a material mixture. The material mixture was charged into a twin-screw extruder having vents (“TEX-30” produced by The Japan Steel Works, LTD.) and melt-kneaded (resin-component output rate: 20 kg/hr, screw rotation speed: 350 rpm, that is, resin-component output rate: 0.057 (kg/hr/rpm), maximum torque: 60 (A), resin temperature: see “Step 1: Cylinder temperature” shown in Tables 1 to 3 below, and die-hole diameter: 3 mm). The melt-kneaded mixture was drawn to form a strand in such a manner that the diameter of a die hole (diameter of the nozzle) and the diameter of the strand (i.e., strand diameter) satisfied the condition of “Die-hole diameter/strand diameter” shown in Tables 1 to 3. The strand was cut and shaped into pellets of a resin composition. The strand diameter was determined by measuring the diameter of the cut pellets using vernier calipers.

The pellets of the resin composition prepared in the previous step and the polyolefin resin-2 shown in Tables 1 to 3 were charged into a twin-screw extruder having vents (“TEX-30” produced by The Japan Steel Works, LTD.) to which a T-die was attached and melt-kneaded (resin-component output rate: 15 kg/hr, screw rotation speed: 200 rpm, that is, resin-component output rate: 0.075 (kg/hr/rpm), maximum torque: 60 (A), resin temperature: see “Step 2: Cylinder temperature” shown in Tables 1 to 3 below) to prepare a melt-kneaded mixture. Subsequently, the melt-kneaded mixture was shaped by T-die extrusion in order to form a sheet having a thickness of 0.1 mm. While being cooled, the sheet was drawn using a cooling roller kept at 80° C. to form a gelatinous sheet in such a manner that the gap of the lip portion (lip width) of the T-die and the thickness of the gelatinous sheet satisfied the condition of “Lip width/sheet thickness” shown in Tables 1 to 3. The thicknesses of a sheet and a membrane were measured using a thickness meter (Digimatic Indicator “ID-130M” produced by Mitutoyo Corporation).

The gelatinous sheet was cut to a size of 60 mm×60 mm and placed in a biaxial stretching test machine. The gelatinous sheet was heated from the room temperature to 120° C., and subjected to simultaneous biaxial stretching to form a stretched sheet in such a manner that the extension ratio was 3 times both in the machine direction (MD) and in transverse direction (TD) perpendicular to MD. The stretched sheet was then subjected to a heat-setting treatment at 125° C. for 10 minutes while being supported by a tenter stretching machine. Thus, a sheet test piece having a thickness of 0.03 mm was prepared.

### (Tensile Strength)

The sheet test pieces prepared in Examples 1 to 8 and Comparative Examples 1 to 3 were each cut to a dumbbell-shaped test piece “Type-5”, and tensile strength of the test piece was measured in accordance with JIS-K7127 “Plastics-Determination of tensile properties”. Tables 1 to 3 summarize the results.

### (Thermal Shrinkage Ratio)

The sheet test pieces prepared in Examples 1 to 8 and Comparative Examples 1 to 3 were each cut to a size of 50 mm×50 mm, and the thermal shrinkage ratio of the sheet test piece was measured by a method conforming to JIS-K7133 “Plastics-Film and sheeting-Determination of dimensional change on heating”. Tables 1 to 3 summarize the results.

### (Determination of Shape of PPS Resin and Calculation of Aspect Ratio of PPS Resin)

Each sheet test piece was cut using a cryomicrotome in transverse direction (TD) perpendicular to the machine direction (MD) in which the sheet was formed, and the cut edge of the test piece was observed using a scanning electron microscope (SEM-EDS “JSM-6360A” produced by JEOL Ltd.). Observation was made at 10 points randomly selected in the resulting image. Then, the length of the longest portion of the PPS resin particle was considered to be the “long side” of the PPS resin particle. The length of the PPS resin particle measured at the midpoint of the long side in a direction perpendicular to the long side was considered to be the “short side” of the PPS resin particle. The number-average of the ratios of the long side to the short side was calculated as the aspect ratio of the PPS Resin.

TABLE 1

| | | | Example | | | |
|---|---|---|---|---|---|---|
| Composition | | | 1 | 2 | 3 | 4 |
| Step 1 | PPS | a1 | 30.0 | | 60.0 | 30.0 |
| | | a2 | | 30.0 | | |
| | Polyolefin-1 | b1 | 65.0 | 65.0 | 35.0 | 65.0 |
| | | b2 | | | | |
| | Compatibilizer | c1 | 5.0 | 5.0 | 5.0 | |
| | | c2 | | | | 5.0 |
| Step 2 | Polyolefin-2 | e1 | | | | |

Processing

| | | | | | |
|---|---|---|---|---|---|
| Step 1 | Cylinder temperature | 300 | 300 | 300 | 300 |
| | Die-hole diameter/strand | 1 | 1 | 1 | 1 |
| | diameter | | | | |
| Step 2 | Cylinder temperature | 300 | 300 | 300 | 300 |
| Step 3 | Lip width/sheet thickness | 5 | 5 | 5 | 5 |

Sheet evaluation

| PPS aspect ratio | | | 20 | 20 | 15 | 25 |
|---|---|---|---|---|---|---|
| Tensile strength [MPa] | | MD | 25 | 25 | 30 | 20 |
| | | TD | 25 | 25 | 15 | 20 |
| Tensile elongation [%] | | MD | 30 | 50 | 3 | 50 |
| | | TD | 3 | 3 | <1 | 3 |
| Thermal | Before | 150° C., | 20 | 20 | 1 | 15 |
| | | 10 min | | | | |
| shrinkage | heat- | 200° C., | 30 | 25 | 1 | 20 |
| ratio [%] | setting | 10 min | | | | |
| Average of | After heat- | 150° C., | 5 | 10 | <1 | 1 |
| | | 10 min | | | | |
| MD and TD | setting at | 200° C., | 20 | 20 | 1 | 15 |
| | 200° C. | 10 min | | | | |
| | for 1 min | | | | | |

* In Table 1, the value regarding to the proportion of each component is expressed in parts by mass. The same applies hereinafter.

TABLE 2

| | | | Example | | | |
|---|---|---|---|---|---|---|
| Composition | | | 5 | 6 | 7 | 8 |
| Step 1 | PPS | a1 | 30.0 | 30.0 | 30.0 | 30.0 |
| | | a2 | | | | |
| | Polyolefin-1 | b1 | | 60.0 | 65.0 | 17.5 |
| | | b2 | 65.0 | | | |
| | Compatibilizer | c1 | 5.0 | 10.0 | 5.0 | 2.5 |
| | | c2 | | | | |
| Step 2 | Polyolefin-2 | e1 | | | | 50.0 |

Processing

| | | | | | |
|---|---|---|---|---|---|
| Step 1 | Cylinder temperature | 300 | 300 | 300 | 300 |
| | Die-hole diameter/strand | 1 | 1 | 2 | 1 |
| | diameter | | | | |
| Step 2 | Cylinder temperature | 300 | 300 | 220 | 300 |
| Step 3 | Lip width/sheet thickness | 5 | 5 | 5 | 5 |

Sheet evaluation

| PPS aspect ratio | | | 20 | 15 | 10 | 15 |
|---|---|---|---|---|---|---|
| Tensile strength [MPa] | | MD | 25 | 25 | 20 | 25 |
| | | TD | 20 | 25 | 20 | 25 |
| Tensile elongation [%] | | MD | 200 | 55 | 15 | 30 |
| | | TD | 140 | 3 | 3 | 3 |
| Thermal | Before | 150° C., | 10 | 20 | 30 | 15 |
| | | 10 min | | | | |
| shrinkage | heat- | 200° C., | 30 | 30 | 30 | 25 |
| ratio [%] | setting | 10 min | | | | |
| Average of | After heat- | 150° C., | 5 | 5 | 15 | 10 |
| | | 10 min | | | | |
| MD and TD | setting at | 200° C., | 25 | 20 | 20 | 20 |
| | 200° C. | 10 min | | | | |
| | for 1 min | | | | | |

TABLE 3

| | | | Comparative Example | | |
|---|---|---|---|---|---|
| Composition | | | 1 | 2 | 3 |
| Step 1 | PPS | a1 | 30.0 | | |
| | | a2 | | | |
| | Polyolefin-1 | b1 | 65.0 | 100.0 | 100.0 |
| | | b2 | | | |
| | Compat- | c1 | | | |
| | ibilizer | c2 | 5.0 | | |
| Step 2 | Polyolefin-2 | e1 | | | |

Processing

| | | | | |
|---|---|---|---|---|
| Step 1 | Cylinder temperature | 300 | — | — |
| | Die-hole diameter/strand | 1 | — | — |
| | diameter | | | |
| Step 2 | Cylinder temperature | 220 | 300 | 220 |
| Step 3 | Lip width/sheet thickness | 5 | 5 | 5 |

Sheet evaluation

| PPS aspect ratio | | | 1 | — | — |
|---|---|---|---|---|---|
| Tensile strength [MPa] | | MD | 25 | 25 | 20 |
| | | TD | 25 | 25 | 25 |
| Tensile elongation [%] | | MD | 40 | 200 | 200 |
| | | TD | 3 | 270 | 300 |
| Thermal | Before heat- | 150° C., 10 min | 30 | 35 | 35 |
| shrinkage | setting | 200° C., 10 min | 35 | 40 | 45 |
| ratio [%] | After heat- | 150° C., 10 min | 10 | — | — |
| Average of | setting at 200° | 200° C., 10 min | 25 | — | — |
| MD and TD | C. for 1 min | | | | |

Microporous membranes were prepared in the following manner, and the thickness, air permeability, and shut-down temperature of each microporous membrane were measured by the following method.

### Examples 9 to 16 and Comparative Examples 4 to 6

The polyphenylene sulfide resin, the polyolefin resin-1, and the thermoplastic elastomer shown in Tables 4 to 6 below were uniformly mixed in a tumbler to prepare a material mixture. The material mixture was charged into a twin-screw extruder having vents (“TEX-30” produced by The Japan Steel Works, LTD.) and melt-kneaded (resin-component output rate: 20 kg/hr, screw rotation speed: 350 rpm, that is, resin-component output rate: 0.057 (kg/hr/rpm), maximum torque: 60 (A), resin temperature: see “Step 1: Cylinder temperature” shown in Tables 4 to 6 below, and die-hole diameter: 3 mm). The melt-kneaded mixture was drawn to form a strand in such a manner that the condition of “Die-hole diameter/strand diameter” shown in Tables 4 to 6 was satisfied. The strand was cut and shaped into pellets of a resin composition.

The pellets of the resin composition prepared in the previous step, the polyolefin resin-2 shown in Tables 4 to 6, and the pore-forming agent (including liquid paraffin and bis(2-ethylhexyl) phthalate in equal amounts) shown in Tables 4 to 6 were charged into a twin-screw extruder having vents (“TEX-30” produced by The Japan Steel Works, LTD.) to which a T-die was attached and melt-kneaded (resin-component output rate: 15 kg/hr, screw rotation speed: 200 rpm, that is, resin-component output rate: 0.075 (kg/hr/rpm), maximum torque: 60 (A), resin temperature: see “Step 2: Cylinder temperature” shown in Tables 4 to 6 below) to prepare a melt-kneaded mixture. Subsequently, the melt-kneaded mixture was shaped by T-die extrusion in order to form a sheet having a thickness of 0.1 mm. While being cooled, the sheet was drawn using a cooling roller kept at 80° C. to form a gelatinous sheet in such a manner that the condition of “Lip width/sheet thickness” shown in Tables 4 to 6 was satisfied.

The gelatinous sheet was cut to a size of 60 mm×60 mm and placed in a biaxial stretching test machine. The gelatinous sheet was heated from the room temperature to 120° C., and subjected to simultaneous biaxial stretching to form a stretched sheet in such a manner that the extension ratio was 3 times both in the machine direction (MD) and in transverse direction (TD) perpendicular to MD. The stretched sheet was fixed in a 20 cm×20 cm aluminium frame and immersed in a pore-forming-agent-removal bath containing methylene chloride (surface tension: 27.3 mN/m (25° C.), boiling point: 40.0° C.) kept at 25° C. While vibrating the stretched sheet at 100 rpm for 10 minutes, the pore-forming agent was removed from the stretched sheet. Subsequently, the stretched sheet was air-dried at room temperature and then subjected to a heat-setting treatment at 125° C. for 10 minutes while being supported by a tenter stretching machine. Thus, a microporous membrane having a thickness of 0.03 mm was prepared.

### (Gurley Air Permeability)

The Gurley air permeability of each microporous membrane was measured in accordance with JIS-P8117 “Paper and board—Determination of air permeance and air resistance (medium range)—Gurley method”. Tables 4 to 6 summarize the results.

### (Shut-Down Temperature)

Each microporous membrane was subjected to a hot-air drying machine kept at a predetermined temperature for 1 minute. A temperature at which the Gurley air permeability of the microporous membrane reached 10000 s/100 ml or more was considered to be the shut-down temperature of the microporous membrane. Tables 4 to 6 summarize the results.

TABLE 4

| | | | Example | | | |
|---|---|---|---|---|---|---|
| Composition | | | 9 | 10 | 11 | 12 |
| Step 1 | PPS | a1 | 30.0 | | 60.0 | 30.0 |
| | | a2 | | 30.0 | | |
| | Polyolefin-1 | b1 | 65.0 | 65.0 | 35.0 | 65.0 |
| | | b2 | | | | |
| | Compatibilizer | c1 | 5.0 | 5.0 | 5.0 | |
| | | c2 | | | | 5.0 |
| Step 2 | Polyolefin -2 | e1 | | | | |
| | Pore-forming agent | d1 | 30.0 | 30.0 | 30.0 | 30.0 |

Processing

| | | | | | |
|---|---|---|---|---|---|
| Step 1 | Cylinder temperature | 300 | 300 | 300 | 300 |
| | Die-hole diameter/strand | 1 | 1 | 1 | 1 |
| | diameter | | | | |
| Step 2 | Cylinder temperature | 300 | 300 | 300 | 300 |
| Step 3 | Lip width/sheet thickness | 5 | 5 | 5 | 5 |

Microporous membrane evaluation

| | | | | |
|---|---|---|---|---|
| Shut-down temperature [° C.] | 140 | 142 | 148 | 140 |
| Gurley air permeability [sec./100 ml] | 610 | 650 | 570 | 600 |

* In Table 4, the value regarding to the proportion of each component is expressed in parts by mass. The same applies hereinafter.

TABLE 5

| | | | Example | | | |
|---|---|---|---|---|---|---|
| Composition | | | 13 | 14 | 15 | 16 |
| Step 1 | PPS | a1 | 30.0 | 30.0 | 30.0 | 30.0 |
| | | a2 | | | | |
| | | a3 | | | | |
| | Polyolefin-1 | b1 | | 60.0 | 65.0 | 17.5 |
| | | b2 | 65.0 | | | |
| | Compatibilizer | c1 | 5.0 | 10.0 | 5.0 | 2.5 |
| | | c2 | | | | |
| Step 2 | Polyolefin -2 | e1 | | | | 50.0 |
| | Pore-forming agent | d1 | 30.0 | 30.0 | 30.0 | 30.0 |

Processing

| | | | | | |
|---|---|---|---|---|---|
| Step 1 | Cylinder temperature | 300 | 300 | 300 | 300 |
| | Die-hole diameter/strand | 1 | 1 | 2 | 1 |
| | diameter | | | | |
| Step 2 | Cylinder temperature | 300 | 300 | 220 | 300 |
| Step 3 | Lip width/sheet thickness | 5 | 5 | 5 | 5 |

Microporous membrane evaluation

| | | | | |
|---|---|---|---|---|
| Shut-down temperature [° C.] | 142 | 138 | 140 | 150 |
| Gurley air permeability [sec./100 ml] | 600 | 570 | 650 | 490 |

TABLE 6

| | | | Comparative example | | |
|---|---|---|---|---|---|
| Composition | | | 4 | 5 | 6 |
| Step 1 | PPS | a1 | 30.0 | | |
| | | a2 | | | |
| | | a3 | | | |
| | Polyolefin-1 | b1 | 65.0 | 100.0 | 100.0 |
| | | b2 | | | |
| | Compatibilizer | c1 | | | |
| | | c2 | 5.0 | | |
| Step 2 | Polyolefin -2 | e1 | | | |
| | Pore-forming agent | d1 | 30.0 | 30.0 | 30.0 |

Processing

| | | | | |
|---|---|---|---|---|
| Step 1 | Cylinder temperature | 300 | — | — |
| | Die-hole diameter/strand diameter | 1 | — | — |
| Step 2 | Cylinder temperature | 220 | 300 | 220 |
| Step 3 | Lip width/sheet thickness | 5 | 5 | 5 |

Microporous membrane evaluation

| | | | |
|---|---|---|---|
| Shut-down temperature [° C.] | 145 | 132 | 133 |
| Gurley air permeability [sec./100 ml] | 520 | 370 | 380 |

The following materials were used as the components shown in Tables 1 to 6.

PPS (a1) “MA-520” produced by DIC Corporation, linear-type, V6 melt viscosity: 150 [Pa·s]

PPS (a2) “MA-505” produced by DIC corporation, linear-type, V6 melt viscosity: 45 [Pa·s]

Polyolefin (b1) “HI-ZEX 5305EP” produced by Prime Polymer Co., Ltd., MI=0.8 (g/10 min)

Polyolefin (b2) “HI-ZEX 3600F” produced by Prime Polymer Co., Ltd., MI=1.0 (g/10 min)

Compatibilizer (c1) “BONDFAST-E” produced by Sumitomo Chemical Co., Ltd. (thermoplastic elastomer that is an ethylene/glycidyl methacrylate (88%/12% by mass) copolymer)

Compatibilizer (c2) “MODIPER A4100” produced by NOF CORPORATION (thermoplastic elastomer produced by grafting polystyrene to an ethylene/glycidyl methacrylate (85%/15% by mass) copolymer in such a manner that the mass ratio of the ethylene/glycidyl methacrylate copolymer to polystyrene is 7:3)

Polyolefin (e1) “HI-ZEX 5305EP” produced by Prime Polymer Co., Ltd., MI=0.8 (g/10 min)

### REFERENCE SIGNS LIST

1: PPS resin having an acicular structure
1′: PPS resin having a spherical structure

1. A microporous membrane comprising a thermoplastic resin having a melting point of 220° C. or more, a polyolefin, and a compatibilizer, the thermoplastic resin having an acicular structure.

2. The microporous membrane according to claim 1, wherein the thermoplastic resin has an aspect ratio of 1.1 to 100.

3. The microporous membrane according to claim 1, wherein the composition ratio between the thermoplastic resin and the polyolefin is such that the amount of the thermoplastic resin is 1% to 73% by mass and the amount of the polyolefin is 99% to 27% by mass of the total mass of the thermoplastic resin and the polyolefin.

4. The microporous membrane according to claim 1,
wherein the composition ratio among the thermoplastic resin, the polyolefin, and the compatibilizer is such that the total mass of the thermoplastic resin and the polyolefin is 90% to 97% by mass and the amount of the compatibilizer is 10% to 3% by mass of the total mass of the thermoplastic resin, the polyolefin, and the compatibilizer.

5. (canceled)

6. The microporous membrane according to claim 1, wherein the compatibilizer is a thermoplastic elastomer including a functional group capable of reacting with the thermoplastic resin.

7. A battery separator for nonaqueous electrolyte secondary batteries, the battery separator comprising the microporous membrane according to claim 1.

8. The battery separator according to claim 7, serving as a single-layer battery separator for nonaqueous electrolyte secondary batteries.

9. A method for producing a microporous membrane, the method comprising the steps of:
(1) melt-kneading a thermoplastic resin (a) having a melting point of 220° C. or more with a polyolefin (b) and a compatibilizer (c) at a temperature equal to or higher than the melting point of the thermoplastic resin (a) to prepare a resin composition (α);
(2) melt-kneading the resin composition (α) with a pore-forming agent (d1) or with a β-phase-nucleating agent (d2) at a temperature higher than the melting point of the thermoplastic resin (a) by 10° C. or more to prepare a melt-kneaded mixture (β);
(3) forming the melt-kneaded mixture (β) into a sheet to prepare a sheet (γ) including the thermoplastic resin (a) having an acicular structure, the melt-kneaded mixture (β) being heated to the temperature higher than the melting point of the thermoplastic resin (a) by 10° C. or more; and
(4) forming pores in the sheet (γ).

10. A method for producing a microporous membrane, the method comprising the steps of:
(1′) melt-kneading a thermoplastic resin (a) having a melting point of 220° C. or more with a polyolefin (b) and a compatibilizer (c) in an extruder at a temperature higher than the melting point of the thermoplastic resin (a) by 10° C. or more, the extruder including a die attached to a side thereof, drawing the resulting melt-kneaded mixture to form a strand in such a manner that the ratio of the diameter of a die hole to the diameter of the strand is 1.1 or more, and subsequently cutting the strand to prepare a resin composition (α′) including the thermoplastic resin (a) having an acicular structure;
(2′) kneading the resin composition (α′) with a pore-forming agent (d1) or with a β-phase-nucleating agent (d2) at a temperature equal to or higher than the melting point of the polyolefin (b) and equal to or lower than the melting point of the thermoplastic resin (a) to prepare a kneaded mixture (β′);
(3′) forming the kneaded mixture (β′) into a sheet to prepare a sheet (γ) including the thermoplastic resin (a) having an acicular structure, the kneaded mixture (β′) being heated to the temperature equal to or higher than the melting point of the polyolefin (b) and equal to or lower than the melting point of the thermoplastic resin (a); and
(4) forming pores in the sheet (γ).

11. A resin composition (α′) used for producing the battery separator for nonaqueous electrolyte secondary batteries according to claim 7, the resin composition (α′) being produced by melt-kneading a thermoplastic resin (a) having a melting point of 220° C. or more with a polyolefin (b) and a compatibilizer (c) in an extruder at a temperature higher than the melting point of the thermoplastic resin (a) by 10° C. or more, the extruder including a die attached to a side thereof, drawing the resulting melt-kneaded mixture to form a strand in such a manner that the ratio of the diameter of a die hole to the diameter of the strand is 1.1 or more, and subsequently cutting the strand,
wherein the composition ratio between the thermoplastic resin (a) and the polyolefin (b) is such that the amount of the thermoplastic resin (a) is 1% to 73% by mass and the amount of the polyolefin (b) is 99% to 27% by mass of the total mass (a+b) of the thermoplastic resin (a) and the polyolefin (b),
wherein the composition ratio among the thermoplastic resin (a), the polyolefin (b), and the compatibilizer (c) is such that the total mass (a+b) of the thermoplastic resin (a) and the polyolefin (b) is 90% to 97% by mass and the amount of the compatibilizer (c) is 10% to 3% by mass of the total mass (a+b+c) of the thermoplastic resin (a), the polyolefin (b), and the compatibilizer (c), and
wherein the thermoplastic resin (a) has an acicular structure.

12-23. (canceled)
